(19) United States
(12) Patent Application Publication
(10) Pub. No.: US 2014/0181257 A1
(43) Pub. Date: Jun. 26, 2014

(54) METHODS AND SYSTEMS FOR LOADING CONTENT IN A NETWORK

(71) Applicant: Alcatel-Lucent USA Inc., Murray Hill, NJ (US)

(72) Inventors: Kamakshi SRIDHAR, Plano, TX (US); Yalou WANG, Swindon (GB)

(73) Assignee: Alcatel-Lucent USA Inc., Murray Hill, NJ (US)

(21) Appl. No.: 13/721,748

(22) Filed: Dec. 20, 2012

(51) Int. Cl. H04L 29/08

(52) U.S. Cl. CPC H04L 67/32
USPC 709/219

(57) ABSTRACT

At least one example embodiment discloses a method of loading content for a user in a network including a plurality of base stations. The method includes obtaining a profile of the user, the profile identifying a history of the user in the network including previous content requested by the user, determining future content to load onto at least a first of the plurality of base stations based on the profile, and instructing a content server to load the future content onto the first base station before receiving a request from the user for the future content.

### BACKGROUND

In mobile networks, users are able to download rich-media such as video content. Currently, video content is delivered to a user upon request through mechanisms that pull in content from servers within the network. Content is pulled in near-real time when needed, even if the network is in congestion.

### SUMMARY

Example embodiments disclose methods and systems for loading content in a network.

The inventors have discovered that intelligence about user preferences was not considered in making intelligent decisions on an appropriate time to pull in video content causing lack of prior visibility into user video preferences or mobility patterns. Consequently, the inventors have discovered methods and systems that take into account a user's preferences in loading content in the network.

Example embodiments disclose mechanisms for rich-media/video content distribution within and among a base station based on intelligence gathered within the network through monitoring of user flows and mobility patterns, for example.

An example embodiment discloses a method of loading content for a user in a network including a plurality of base stations. The method includes obtaining a profile of the user, the profile identifying a history of the user in the network including previous content requested by the user, determining future content to load onto at least a first of the plurality of base stations based on the profile, and instructing a content server to load the future content onto the first base station before receiving a request from the user for the future content.

In one example embodiment, the method further includes receiving a request for the future content from the user.

In one example embodiment, the determining future content includes determining the first of the plurality of base stations based on movement of the user.

In one example embodiment, the determining the first of the plurality of base stations is performed periodically.

In one example embodiment, the determining determines future content to load based on a time of day.

In one example embodiment, the method further includes determining the time of day based on a history of traffic of the network, wherein the instructing instructs the content server to load the future content during the determined time of day.

In one example embodiment, the determining future content includes determining a probability the user will request the future content.

In one example embodiment, the instructing instructs the content server based on the probability the user will request the future content.

In one example embodiment, the method further includes determining an effect of loading the future content and adjusting a version of the future content based on the determined effect.

An example embodiment discloses a network monitor configured to obtain a profile of user in the network, the profile identifying a history of the user in the network including previous content requested by the user determine future content to load onto at least a first of a plurality of base stations based on the profile, and instruct a content server to load the future content onto the first base station before receiving a request from the user for the future content.

In one example embodiment, the network monitor is further configured to receive a request for the future content from the user.

In one example embodiment, the network monitor is further configured to determine the first of the plurality of base stations based on movement of the user.

In one example embodiment, the network monitor is further configured to determine the first of the plurality of base stations is performed periodically.

In one example embodiment, the network monitor is further configured to determine future content to load based on a time of day.

In one example embodiment, the network monitor is further configured to determine the time of day based on a history of traffic of the network and instruct the content server to load the future content during the determined time of day.

In one example embodiment, the network monitor is further configured to determine a probability the user will request the future content.

In one example embodiment, the network monitor is further configured to instruct the content server based on the probability the user will request the future content.

In one example embodiment, the network monitor is further configured to determine an effect of loading the future content and adjust a version of the future content based on the determined effect.

### BRIEF DESCRIPTION OF THE DRAWINGS

Example embodiments will be more clearly understood from the following detailed description taken in conjunction with the accompanying drawings. FIGS. 1-3 represent non-limiting, example embodiments as described herein.

FIG. 1 illustrates a network according to an example embodiment;

FIG. 2 illustrates a method of loading content for a user in a network; and

FIG. 3 illustrates a network monitor 126 according to an example embodiment.

### DETAILED DESCRIPTION

Various example embodiments will now be described more fully with reference to the accompanying drawings in which some example embodiments are illustrated.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

As disclosed herein, the term “storage medium”, “storage unit” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

As used herein, the term “user equipment” or “UE” may be synonymous to a user equipment, mobile station, mobile user, access terminal, mobile terminal, user, subscriber, wireless terminal, terminal and/or remote station and may describe a remote user of wireless resources in a wireless communication network. Accordingly, a UE may be a wireless phone, wireless equipped laptop, wireless equipped appliance, etc.

The term “base station” may be understood as a one or more cell sites, base stations, nodeBs, enhanced NodeBs, access points, and/or any terminus of radio frequency communication. Although current network architectures may consider a distinction between mobile/user devices and access points/cell sites, the example embodiments described hereafter may also generally be applicable to architectures where that distinction is not so clear, such as ad hoc and/or mesh network architectures, for example.

Communication from the base station to the UE is typically called downlink or forward link communication. Communication from the UE to the base station is typically called uplink or reverse link communication.

Serving base station may refer to the base station currently handling communication needs of the UE.

Example embodiments disclose mechanisms for rich-media/video content distribution within and among a base station based on intelligence gathered within the network through monitoring of user flows and mobility patterns, for example.

An example embodiment discloses a method of loading content for a user in a network including a plurality of base stations. The method includes obtaining a profile of the user, the profile identifying a history of the user in the network including previous content requested by the user, determining future content to load onto at least a first of the plurality of base stations based on the profile, and instructing a content server to load the future content onto the first base station before receiving a request from the user for the future content.

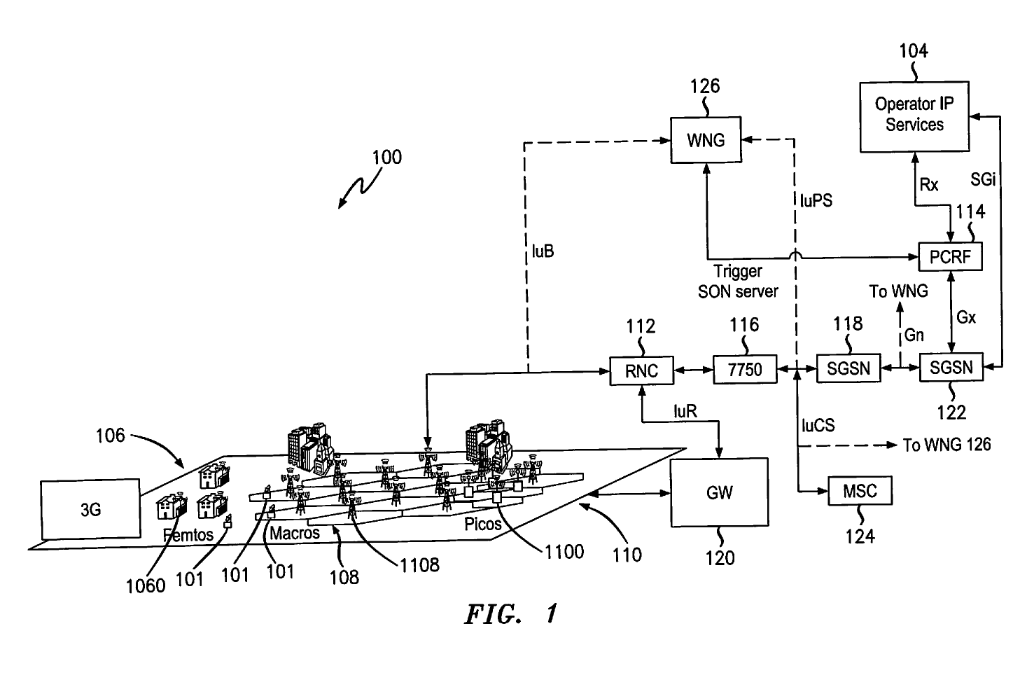

FIG. 1 illustrates a network according to an example embodiment. A network 100 is a 3G network implementing Wideband Code Division Multiple Access (WCDMA). While an example embodiment is described with reference to 3G network, it should be understood that example embodiments may be implemented in various other networks such as Long Term Evolution (LTE, 4G) networks.

The network 100 serves a geographic area divided into cells, where user equipments (UEs) 101 in each cell are served by a respective base station (referred to herein as an eNB or eNodeB). The network 100 in FIG. 1 is divided into femto cells 106, pico cells 110 and macro cells 108. Each of the femto cells 106 is served by a femto eNB 1060, each of the pico cells 110 is served by a pico eNB 1100, and each of the macro cells 108 is served by a macro eNB 1080.

The core network associated with the RANs includes a radio network controller (RNC) 112 configured to communicate with the eNBs 1060, 1080, 1100. The network includes femto cells, pico cells and macro cells. As is well known, however, 3G and LTE RANs may include one or more of femto cells, pico cells and macro cells.

Still referring to FIG. 1, the GW 120 is based on the Iuh architecture. Each metro cell/femto cell in the 3G architecture functions as a RNC integrated into the access point. The gateway simply serves to shield the core network by appearing as one virtual RNC to the rest of the core network rather than multiple RNCs. The gateway is connected to the 3G metro cells via the Iuh interface.

The radio network controller (RNC) 112 communicates with the eNBs 1060, 1080, 1100 of the network 100 via a luB interface. The RNC 112 also communicates with the GW 120 via a luR interface. It will be appreciated that the network architecture may include more than one radio network controller (RNC), GW, etc. and additional eNBs associated with the additional core network resources to serve a larger geographic area.

A 7750 116 serves as a router to route traffic to the various core network nodes. The 7750 116 is an optional element in the architecture and is, at times, part of a security gateway router.

A mobile switching center (MSC) 124 communicates with the RNC 112 over a luCS interface through the 7750 116.

A serving GPRS support node (SGSN) 118 communicates with the RNC 112 over a luPS interface. The SGSN 118 also communicates with a gateway GPRS support node (GGSN) 122 over a Gn interface.

A policy and charging rules function (PCRF) (also referred to as a PCRF node) 114 communicates with the GGSN 122 over a Gx interface.

As is known, the PCRF 114 determines policy rules in a multimedia network. The PCRF 114 is a part of the core network. The PCRF 114 supports the creation of rules and makes policy decisions for active subscribers on the network. In one example, the PCRF 114 controls quality of service (QoS) rules for the network. Each PCRF 114 has a table that contains user profiles for each user.

The output of a centralized SON and policy (CSONP) server (not shown), which is discussed in more detail below, is combined with outputs from the PCRF 114 to determine the degree of optimizations to which each user should be subjected. The process of optimization considers different user profiles in deciding which users can be meted out with optimizations and to what extent. The output of the centralized SON and policy server is combined with the outputs of the PCRF 114 to decide which users should be given the additional optimization in terms of preloading of content and hence likely higher user QoE (Quality of Experience) due to removal of backhaul bandwidth constraints. The user profiles include information such as which users have higher QoE. Preloading content at the base station may be done for those users who are eligible for higher QoE. The user profile also includes information on which users are long term subscribers and have shown customer loyalty. Again, preloading content at the base station may be done for those users to improve their QoE.

The PCRF 114 also communicates with operator IP services node 104. The operator IP services node 104 is a suite of content-rich, IP video, voice, data IMS services and non-IMS services.

A network monitor 126 monitors network patterns, loading and traffic over interfaces luB, luPS, luCS and GN. The network monitor 126 may be an Alcatel-Lucent 9900 Wireless Network Guardian (WNG), for example.

The 9900 Wireless Network Guardian (WNG) is a mobile network analytics product that offers network performance, subscriber QoE and trend analysis. It is a real-time, multi-vendor, multi-technology (2.5G/3G/LTE) product that passively taps into the mobile signaling and IP flows generated by the devices across the RAN, backhaul and packet core. The 9900 WNG correlates 6 dimensions in real-time (subscriber, device, application, network, signaling and IP flow), performs multi-stage algorithms and offers expert forensics services. The 9900 WNG measures performance, detects anomalies and congestion, reports airtime, signaling and bandwidth resource consumption; it also analyzes trends per node, device type, technology and application.

The network monitor 126 is configured get a complete picture of the network resources (RAN and core) and the users on the network.

The network monitor 126 can detect:
1) Which base stations are more congested, which base stations are less congested within a geographic area that has a set of contiguous base stations;
2) Features/capabilities of base stations (e.g., capacity and type); and
3) Details on user behavior, which include:
   a) which users are on which base stations (eNB, HeNB, NB),
   b) what are the video preferences for those users,
   c) what are the mobility patterns for those users, and
   d) which applications (e.g., specific video apps) are favored by the various users.

The network monitor 126 can correlate the network view (relative loading on various base stations) and user information (e.g., apps and mobility). The network monitor determines which users are connected to which base stations at various times and the type of content viewed during those times. User mobility patterns and viewing behavior, particularly for mobile video, being relatively predictable, the network monitor correlates whether there was a consistent pattern where certain users were watching specific content (video content) at specific times of the day for a certain number of days. Having made that correlation, the network monitor then decides which content should be distributed to which base station for likely use within a next time window.

The time window may be determined based on traffic patterns or set based on empirical data. For example, the time window may be 10 minutes. At specific times, the network monitor 126 requests specific content either from the content server or from the satellite, targeted for use within the next say time window.

The content to be distributed can be pre-cached in certain network elements, such as SGW in LTE or SGSN/GGSN in WCDMA networks.

Through this approach, content can be preloaded at the base stations 1060, 1108, 1100 during times of low congestion. This content is preloaded recognizing that it is likely needed by the user in the near future, based on the predicted UE mobility pattern.

The network monitor 126 detects the mobility pattern by monitoring which base station the UEs are attached to over a period of time. By knowing how many base stations the UE has traversed in a period of time, the network monitor 126 can classify the UE as a low mobility or a high mobility user. The network monitor 126 can also tap into the MME (not shown) that knows the UE mobility across the network 100 based on handoff information received from the eNBs 1060, 1080, 1100.

If the UE mobility pattern has changed, and the statistics suggest that the future trend of mobility is to leave the base stations 1060, 1108, 1100, the pre-loaded content may be deleted by any network element storing the pre-loaded content. The method of video distribution can use IP multicast (from video server to multicast group), with dynamically updated multicast group subscriptions (set of base stations).

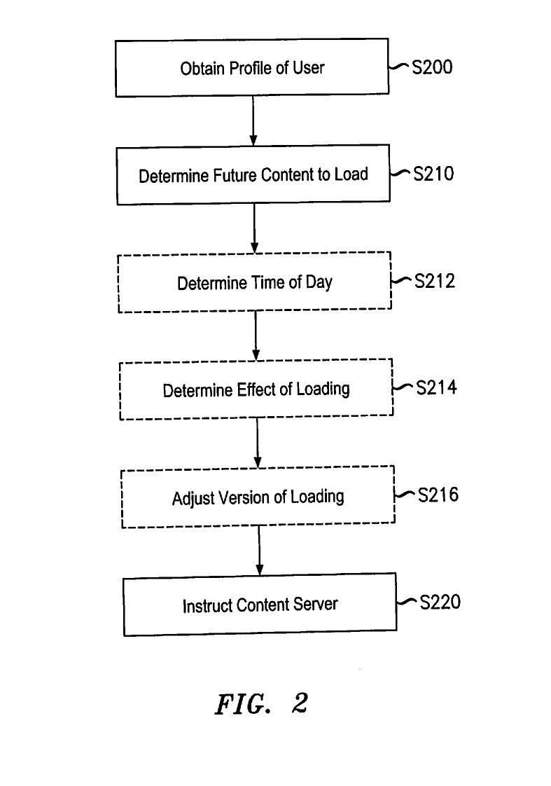

This is described in greater detail with regards to FIG. 2.

FIG. 2 illustrates a method of loading content for a user in a network. The method of FIG. 2 may be performed by the network monitor 126 described in FIG. 1, for example.

In example embodiments, content servers store content requested by users. The content servers are part of the operator IP services node 104.

At S200, the network monitor obtains a profile of the user. The profile identifies a history of the user in the network. The history includes previous content requested by the user. The profile includes dates, times, durations and content watched and/or retrieved by the user. Moreover, the profile may indicate whether that content was paid for or free.

The network monitor supports real-time mobile data network monitoring and analysis. The network monitor taps into the various interfaces passively (e.g., Iu-PS, S1-U and S1-MME) and looks at a 5-tuple of every header in every IP packet. The network monitor stores the 5-tuple temporarily and then analyses the 5-tuple to determine various information such a cell ID of the base station, delays/packet loss for packets, throughput and user mobility.

At S210, the network monitor determines future content to load to network elements in the network. For example, the user's profile may indicate that the user watches an episode of the same TV show every day at 7 PM. Consequently, the network monitor determines that a next episode of the same TV show should be loaded onto a network element, such as the base station serving the user, before 7. In an example embodiment, the network monitor determines to preload content if a user has view a same type of content for over a threshold number of times.

In an example embodiment, a two-level approach can also be used. For example, video to be distributed to a node (decided by the mobility prediction of the network monitor) which is one level up above the base stations, i.e., RNC 112 or SGW in LTE. This first level still uses an IP multicast method (a group of RNCs). Then a second level IP multicast can happen (no need to wait for first level completed) between one such RNC and one set of base stations.

Moreover, the network monitor deter mines which network elements are to receive the preloaded content based on the movement of the user. For example, the network monitor determines to send the content to only the serving base station when there is a high likelihood that the user will not move. Alternatively, the network monitor may determine to send the content to a plurality of base stations if the user has a high mobility.

The network monitor monitors history of users' movement for over 24 hours. The network monitor transmits content to the base stations that are judged by the network monitor to be connected to by a user for a time duration longer than a threshold. This includes also target handoff base stations to which a user is connected to. Since video is generally viewed by users who are relatively stationary, users are generally connected to no more than a few base stations over a certain duration of time.

The network monitor may make this determination periodically and may determine the content to load based on the time of day. For example, the network monitor may instruct the content server to load the content that is watched at a certain time of day.

In an example embodiment, the network monitor determines the future content based on a probability the user will request the future content. More specifically, based on the profile of the user, the network monitor determines a probability the user will request the future content. If the probability is below a threshold, the network monitor determines no future content to be loaded.

In an example embodiment, the network monitor determines a time of day the content server should transmit the content to the determined base station, at S212. For example, the network monitor determines the time to load the content based on a history of traffic of the network. In this case, the network monitor determines the content to be loaded during a time when traffic is generally below a threshold.

In an example embodiment, at S214 and S216, the network monitor determines an effect of loading the content on the network and adjusts a version of the content based on the determined effect.

Video may be delivered in different formats to the UE with different compression schemes. Based on the network loading, the network monitor may decide to download different types of video (low, medium and high resolution video) to the base station. For example, if there is high loading, the network monitor determines to download low resolution video to the base station.

At S220, the network monitor instructs the content server to load the future content onto the determined network elements. In an example embodiment, the network monitor instructs the content server based on a probability the user will request the future content. More specifically, based on the profile of the user, the network monitor determines a probability the user will request the future content. If the probability is above a threshold, the network monitor instructs the content server to load the future content.

Upon receiving a request for the future content, the base station serving the user and storing the preloaded future content transmits the future content to the user. Because the method of FIG. 2 takes into account a user's profile in loading content in the network, the time to deliver the content to the user is reduced.

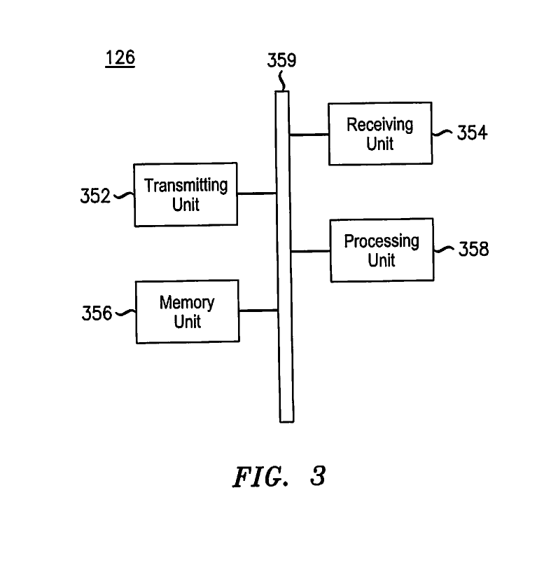

FIG. 3 illustrates the network monitor 126 in more detail. Referring to FIG. 3, the network monitor 126 may include, for example, a data bus 359, a transmitting unit 352, a receiving unit 354, a memory unit 356, and a processing unit 358.

The transmitting unit 352, receiving unit 354, memory unit 356, and processing unit 358 may send data to and/or receive data from one another using the data bus 359. The transmitting unit 352 is a device that includes hardware and any necessary software for transmitting wired and/or wireless signals including, for example, data signals and control signals, via one or more wired and/or wireless connections to other network elements in the wireless communications network 100.

The receiving unit 354 is a device that includes hardware and any necessary software for receiving wired and/or wireless signals including, for example, data signals and control signals, via one or more wired and/or wireless connections to other network elements in the wireless communications network 100.

The memory unit 356 may be any device capable of storing data including magnetic storage, flash storage, etc. The memory unit 356 may store codes or programs for operations of the processing unit 358. For example, the memory unit 356 may include a data structure including instructions to execute the method described in reference to FIG. 2.

The memory unit 356 may include one or more memory modules. The memory modules may be separate physical memories (e.g., hard drives), separate partitions on a single physical memory and/or separate storage locations on a single partition of a single physical memory. The memory modules may store information associated with the installation of software (e.g., imaging processes).

The processing unit 358 may be any device capable of processing data including, for example, a microprocessor configured to carry out specific operations based on input data, or capable of executing instructions included in computer readable code.

For example, the processing unit 358 is obtain a profile of user in the network, the profile identifying a history of the user in the network including previous content requested by the user, determine future content to load onto at least a first of a plurality of base stations based on the profile and instruct a content server to load the future content onto the first base station before receiving a request from the user for the future content.

The processing unit 358 is further configured to receive a request for the future content from the user.

The processing unit 358 is further configured to determine the first of the plurality of base stations based on movement of the user.

The processing unit 358 is further configured to determine the first of the plurality of base stations is performed periodically.

The processing unit 358 is further configured to determine future content to load based on a time of day.

The processing unit 358 is further configured to determine the time of day based on a history of traffic of the network and instruct the content server to load the future content during the deter mined time of day.

The processing unit 358 is further configured to determine a probability the user will request the future content.

The processing unit 358 is further configured to instruct the content server based on the probability the user will request the future content.

The processing unit 358 is further configured to determine an effect of loading the future content and adjust a version of the future content based on the determined effect.

The memory unit 356 may store executable instructions corresponding to each of the operations described in FIG. 2.

Example embodiments being thus described, it will be obvious that the same may be varied in many ways. Such variations are not to be regarded as a departure from the spirit and scope of example embodiments, and all such modifications as would be obvious to one skilled in the art are intended to be included within the scope of the claims.

What is claimed is:

1. A method of loading content for a user in a network including a plurality of base stations, the method comprising:
obtaining a profile of the user, the profile identifying a history of the user in the network including previous content requested by the user;
determining future content to load onto at least a first of the plurality of base stations based on the profile; and
instructing a content server to load the future content onto the first base station before receiving a request from the user for the future content.

2. The method of claim 1, further comprising:
receiving a request for the future content from the user.

3. The method of claim 1, wherein the determining future content includes,
determining the first of the plurality of base stations based on movement of the user.

4. The method of claim 3, wherein the determining the first of the plurality of base stations is performed periodically.

5. The method of claim 1, wherein the determining determines future content to load based on a time of day.

6. The method of claim 5, further comprising:
determining the time of day based on a history of traffic of the network, wherein the instructing instructs the content server to load the future content during the determined time of day.

7. The method of claim 1, wherein the determining future content includes,
determining a probability the user will request the future content.

8. The method of claim 7, wherein the instructing instructs the content server based on the probability the user will request the future content.

9. The method of claim 1, further comprising:
determining an effect of loading the future content; and
adjusting a version of the future content based on the determined effect.

10. A network monitor configured to,
obtain a profile of user in the network, the profile identifying a history of the user in the network including previous content requested by the user;
determine future content to load onto at least a first of a plurality of base stations based on the profile; and
instruct a content server to load the future content onto the first base station before receiving a request from the user for the future content.

11. The network monitor of claim 10, further configured to receive a request for the future content from the user.

12. The network monitor of claim 10, further configured to determine the first of the plurality of base stations based on movement of the user.

13. The network monitor of claim 12, further configured to determine the first of the plurality of base stations is performed periodically.

14. The network monitor of claim 10, further configured to determine future content to load based on a time of day.

15. The network monitor of claim 14, further configured to determine the time of day based on a history of traffic of the network and instruct the content server to load the future content during the determined time of day.

16. The network monitor of claim 10, further configured to determine a probability the user will request the future content.

17. The network monitor of claim 16, further configured to instruct the content server based on the probability the user will request the future content.

18. The network monitor of claim 10, further configured to determine an effect of loading the future content and adjust a version of the future content based on the determined effect.
